(19) United States
(12) Patent Application Publication
(10) Pub. No.: US 2025/0141882 A1
(43) Pub. Date: May 1, 2025

(54) ADDRESS VERIFICATION BY VISUALLY DISPLAYING THE ADDRESS IN CODED FORM

(71) Applicant: WAGO Verwaltungsgesellschaft mbH, Minden (DE)

(72) Inventors: Alexander BUELOW, Stadthagen (DE); Michael LANGREDER, Hessisch Oldendorf (DE)

(73) Assignee: WAGO Verwaltungsgesellschaft mbH, Minden (DE)

(21) Appl. No.: 19/012,522

(22) Filed: Jan. 7, 2025

Related U.S. Application Data
(63) Continuation of application No. PCT/EP2023/067210, filed on Jun. 24, 2023.

(30) Foreign Application Priority Data
Jul. 7, 2022 (DE) 10 2022 116 955.3

(51) Int. Cl. H04L 9/40; G06F 3/14

(52) U.S. Cl. CPC H04L 63/12; G06F 3/14

(57) ABSTRACT

An input/output device and a method for verifying an address of an input/output device are provided. The input/output device comprises an input and/or an output, a bus interface, a memory and a plurality of light-emitting components. The input and/or the output is configured for connecting field devices. The bus interface is configured for the indirect or direct connection of the field devices to a field bus. The memory is configured to store an address. The input/output device is configured to receive data directed to the address via the bus interface. The input/output device is further configured to display the address in coded form using the light-emitting components.

This nonprovisional application is a continuation of International Application No. PCT/EP2023/067210, which was filed on Jun. 24, 2023, and which claims priority to German Patent Application No. 10 2022 116 955.3, which was filed in Germany on Jul. 7, 2022, and which are both herein incorporated by reference.

### BACKGROUND OF THE INVENTION

### Field of the Invention

This present description relates to the verification of an address intended for use in electronic data communication. In particular, the present description relates to the verification of an address for establishing a communication channel between an input/output device (I/O device) and a controller, which is provided with added security (compared to other standard communication channels).

### Description of the Background Art

I/O devices may be connected to a network or a higher-level controller via (wired) bus interfaces such as local bus and field bus interfaces and may therefore send data to the higher-level controller via the bus interfaces and/or receive data from the higher-level controller. To establish a communication channel between two bus participants, addresses are often used based on which the bus participants can determine whether a message transmitted over the bus is addressed to them. Since errors may occur during address assignment, it may be advantageous or (depending on the respective security level) necessary, particularly for establishing security-related communication channels (i.e., communication channels that are secured in a specific way and are typically more secure than standard communication channels), to verify an assigned address before use in order to be able to detect and correct errors in the address assignment.

### SUMMARY OF THE INVENTION

An input/output device according to the invention comprises an input and/or an output, a bus interface, a memory, and a plurality of light-emitting components. The input and/or output can be configured for connecting field devices and the bus interface is configured for the indirect or direct connection of the field devices to a field bus. Furthermore, the memory is configured to store an address. The I/O device is further configured to receive data addressed to the address via the bus interface and to display the address in coded form using the light-emitting components.

In this regard, the term “input” and “output” as used throughout the description, can be understood, for example, as referring to an electrical connection. It may be provided that voltages and/or currents at, or through, an input of an I/O module are generated by another device and voltages and/or currents at, or through, an output of an I/O module are generated by the I/O module itself. For example, a field device which provides state signals or processes control signals may be connected to the input and/or the output. In this regard, the term “field device”, as used throughout the present description and the claims, can be understood, for example, as referring to a sensor or actuator which is connected (in terms of signaling) to the I/O device during operation.

Furthermore, the term “bus interface”, as used throughout the present description and the claims, can be understood, for example, as referring to a bus interface which is configured for connecting to a local bus and for exchanging (process) data with another I/O device or a fieldbus coupler, or for direct connection to a fieldbus. In this regard, the term “local bus”, as used throughout the present description, can be understood, for example, as referring to a bus via which (only) I/O devices connected to a fieldbus coupler are (directly) connected to one another or to the fieldbus coupler. If, however, the bus interface is configured to be connected to the fieldbus directly (and thus not via a local bus and a fieldbus coupler), the term “bus interface”, as used throughout the present description and the claims, can be understood, for example, as referring to a fieldbus interface.

Furthermore, the term “memory” as used throughout the present description and the claims can be understood, for example, as referring an electronic memory on which data relating to a configuration of the I/O device may be stored. The configuration may, for example, determine how process images are to be generated (e.g., how process data-representing a specific point in time or a specific period of time—are to be derived from signals input at the inputs of the I/O device and how said process data are to be transmitted to the fieldbus coupler via the local bus) and/or how control signals are to be derived from process data transmitted from the fieldbus coupler to the I/O device via the local bus (which may then be output, for example, at an output of the I/O device). If the bus interface is configured to be connected directly to the fieldbus, the configuration may determine, for example, how said process data is to be transmitted via the fieldbus to a higher-level controller and/or how control signals are to be derived from process data that is transmitted from the higher-level controller to the I/O device via the fieldbus.

Furthermore, the term “light-emitting component”, as used throughout the present description and the claims, can be understood, for example, as referring to a component which is configured to be excited to emit light by means of a current flowing through the component, such as, for example, a light-emitting semiconductor component of a light-emitting diode (LED). In this context, it is to be noted that, based on the understanding just described, a multi-colored light-emitting diode may comprise several light-emitting components that emit light of different wavelengths or wavelength ranges.

Furthermore, the term “coded form”, as used throughout the present description and the claims, can be understood, for example, as referring to an assignment resulting from a unique mapping between the address and a pattern displayed by the light-emitting components.

The I/O device may be an I/O module. In this regard, the term “module” as used throughout the present description can be understood, for example, as referring to a device which is configured to be electrically connected to another device in order to extend the capabilities of this device, so that both devices form a functional unit. It may be the case that both devices are configured to be connected to each other not only electrically but also mechanically, so that the devices form a unit not only functionally but also mechanically.

An I/O module may, for example, comprise a housing which is configured to connect the I/O module to another I/O module or to a fieldbus coupler. In this regard, the term “housing”, as used throughout the description can be understood, for example, as referring to a structure made of a solid insulating material into which conductive structures are embedded, wherein the housing is typically designed in such a way that an accidental contact with current-carrying conductors is essentially impossible. Furthermore, the term “serially connecting”, as used throughout the description, can be understood, for example, as referring to the creation of a frictional or positive connection between housings, by means of which several I/O modules may be connected to one another in series. The housings may be equipped in such a way that the wired transmission path is established as part of the serially connecting (without any further action).

Furthermore, the term “fieldbus coupler”, as used throughout the present description and the claims, can be understood, for example, as referring to a component of a modular fieldbus node that is tasked with making data and/or services of the I/O modules connected to the fieldbus coupler available via a fieldbus to which the fieldbus coupler is connected.

The data addressed to the address may be comprised in a message addressed to the bus interface. The I/O device may be configured to extract the address from the message and store it in the memory. This means that the bus interface may already have a bus address via which communication may take place. The address may then be used to establish a secure communication channel, which is realized based on the messages addressed to the bus interface. For example, using the address intended for the safe communication channel may prevent that an error in the bus interface addressing causes the I/O device to use data that is not intended for the I/O device to implement a safety-related function.

The address provided for the implementation of a safety-related function may thus be used as an additional security mechanism that ensures that data transmitted via the secure communication channel reaches the intended recipient with a higher probability or that data not intended for the I/O device is discarded by the device. Furthermore, the I/O device may apply a (forward) error correction algorithm to the message, or the data contained in the message and/or evaluate a checksum (contained in the message or the data) in order to detect and, if necessary, correct errors in the message or the data.

The I/O device may be configured to use the address in response to a verification of the address to establish a communication channel secured by other security mechanisms than the message addressed to the bus interface. For example, the I/O device may be configured to wait for a confirmation from a user or commissioning engineer after displaying the address in coded form and to use the address only if the confirmation is received. The correctness of the displayed address may be verified by an input on the I/O device (e.g., by pressing a button on the I/O device) or by sending a confirmation message to the bus interface.

Furthermore, the I/O device may be configured to permanently store the address (possibly supplemented by a checksum) and to use the address to establish the communication channel when the I/O device is restarted only if the (continued) validity of the address is confirmed by a higher-level device. For example, after a restart, the I/O device may wait to receive an address from the higher-level control unit and, if the received address and the stored address match, continue to use it. In addition to the received address, a checksum may be transmitted, which may be used to verify the correctness of the address. Furthermore, the I/O device may be configured to reset the address in response to receiving a reset request so that a new address can be received and stored. The reset request may, for example, comprise the I/O device receiving a predetermined address instead of the correct address after a restart, for example a specific address that lies in an invalid address range.

The address received from the I/O device after a restart may be comprised in a message (or a message sequence) that comprises further configuration data that further defines or at least relates to the communication channel to be established using the address or the data that is exchanged via the communication channel. This configuration data may also be verified, for example, by evaluating a checksum appended to the configuration data or by comparing the configuration data with configuration data stored on the I/O device.

The I/O device may be configured to display the address in digitally coded form using the light emitting components.

In this context, the term “digitally coded”, as used throughout the present description and the claims, can be understood, for example, as referring to coding in which each character of a character string representing the address is mapped to a discrete state (e.g., inactive, active) of one of the plurality of light-emitting components.

The address may comprise a sequence of zeros and ones, and the I/O device may be configured to display a zero or a one in the sequence by deactivating or activating a light-emitting component.

A first group of the light emitting components may be configured to emit light of a first wavelength and a second group of the light emitting components may be configured to emit light of a second wavelength, wherein the first wavelength and the second wavelength correspond to different colors.

For example, the light emitting components may be comprised of multi-colored light emitting diodes (LEDs), and a light emitting diode may emit green to represent a “0” and emit red to represent a “1”. Using different colors to display the character string may be advantageous in that a defective LED can be detected at any time.

The I/O device may be configured to display segments of the sequence sequentially and the zeros and/or ones in each segment simultaneously.

For example, if 2 LEDs are available and the string representing the address has 6 characters, the address may be broken down into 3 segments which are displayed one after the other (segment 1: characters 1 and 2, segment 2: characters 3 and 4, segment 3: characters 5 and 6; LED 1: characters 1, 3 and 5, LED 2: characters 2, 4 and 6).

The I/O device may be configured to display a segment at a particular time by deactivating or activating individual light-emitting components.

The I/O device may be configured to output a sequence-independent optical, acoustic, or haptic signal after the last segment and/or before the first segment, which signals the end of a presentation of the sequence and/or the beginning of the presentation of the sequence.

For example, the I/O device may be configured to (briefly) flash all light-emitting components, emit a beep, or vibrate after the last segment and/or before the first segment.

The I/O device may be configured to reboot the I/O device in response to an address confirmation and/or to use some or all of the light-emitting devices to display additional information.

A method according to the invention for checking an address of an I/O device comprises storing the address in a memory of the I/O device and verifying the address by optically displaying the address in coded form.

The address may comprise a sequence of zeros and ones, and the I/O device may be configured to display a zero or a one in the sequence by deactivating or activating a light-emitting component of the I/O device.

Furthermore, it is noted that all steps carried out when using the I/O device may, in principle, be features of the corresponding method and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic illustration of a fieldbus system;

FIG. 2 shows a schematic illustration of a fieldbus node of the fieldbus system shown in FIG. 1;

FIG. 3 illustrates the configuration of the fieldbus node shown in FIG. 2 by a computer connected to the fieldbus node;

FIG. 4 illustrates the structure of an I/O module to which a field device is connected;

FIG. 5 illustrates a first possible presentation of a first address in coded form;

FIG. 6 illustrates a second possible presentation of the first address in coded form;

FIG. 7 illustrates a first possible presentation of a second address in coded form;

FIG. 8 illustrates a second possible presentation of the second address in coded form; and

FIG. 9 illustrates a sequence of steps for verifying an address of an I/O device.

### DETAILED DESCRIPTION

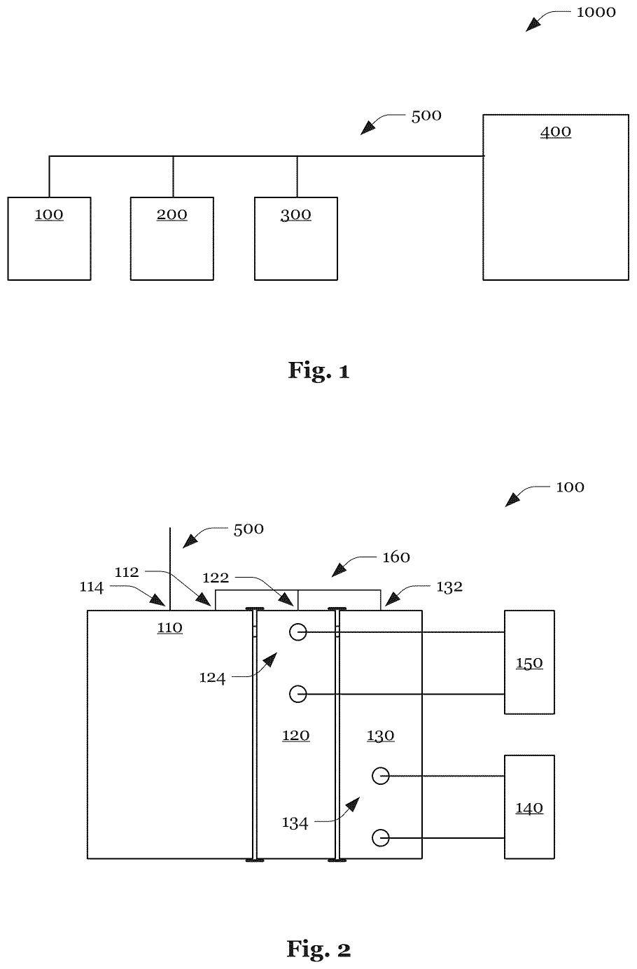

FIG. 1 shows a block diagram of fieldbus system 1000. Fieldbus system 1000 comprises fieldbus nodes 100, 200, 300 and 400, which are interconnected by fieldbus 500. Fieldbus node 400 is a higher-level control unit and may be used both, for monitoring and for controlling, an installation that is controlled by fieldbus system 1000. If the higher-level control unit 400 monitors an installation, the higher-level control unit 400 may cyclically or acyclically receive state data describing the state of the installation from one or more of the fieldbus nodes 100, 200, and 300 and generate an alarm signal if the state of the installation deviates (substantially) from a desired/permitted state or state range. If higher-level control unit 400 (not only monitors but also) controls the installation, the higher-level control unit 400 may cyclically or acyclically receive state data from one or more of fieldbus nodes 100, 200 and 300 and, taking the state data into account, determine control data that is transmitted to one or more of the fieldbus nodes 100, 200 and 300.

FIG. 2 shows a modular fieldbus node 100, including a fieldbus coupler 110 and two I/O modules 120 and 130 serially connected to the fieldbus coupler 110, to which a sensor 140 and an actuator 150 are connected. During operation, the I/O module 130 reads sensor signals via the input 134 and generates state data from the sensor signals, which are transmitted to the fieldbus coupler 110 via the bus interface 132 of the I/O module 130, the local bus 160 and the bus interface 112 (of the fieldbus coupler 110). In addition to the fieldbus interface 114, the fieldbus coupler 110 may have a processor and a memory in which information regarding the configuration of the fieldbus coupler 110 is stored.

The information regarding the configuration of the fieldbus coupler 110 may, for example, indicate which or how many I/O modules 120, 130 are connected to the fieldbus coupler 110 and how the fieldbus coupler 110 should handle the received state data. The fieldbus coupler 110 may, for example, be configured to process the state data locally and/or to forward it (possibly in modified form) to the higher-level control unit 400 via the fieldbus interface 114 and the fieldbus 500. The higher-level control unit 400 (or, in the case of local processing, the fieldbus coupler 110) may then generate control data taking the state data into account.

The control data generated by the higher-level control unit 400 may then be transmitted to the fieldbus coupler 110 via the fieldbus 500. The control data transmitted to the fieldbus coupler 110 (or generated by the fieldbus coupler 110 during purely local processing) are then forwarded/transmitted (possibly in modified form) to the I/O module 120. The I/O module 120 receives the control data and outputs control signals corresponding to the control data at the output 124 to which the actuator 150 is connected. The communication of data between the components of the fieldbus system 1000 and the mapping of the sensor signals to state data and the mapping of the control data to control signals may be adapted to different application scenarios by configuring the fieldbus node 100.

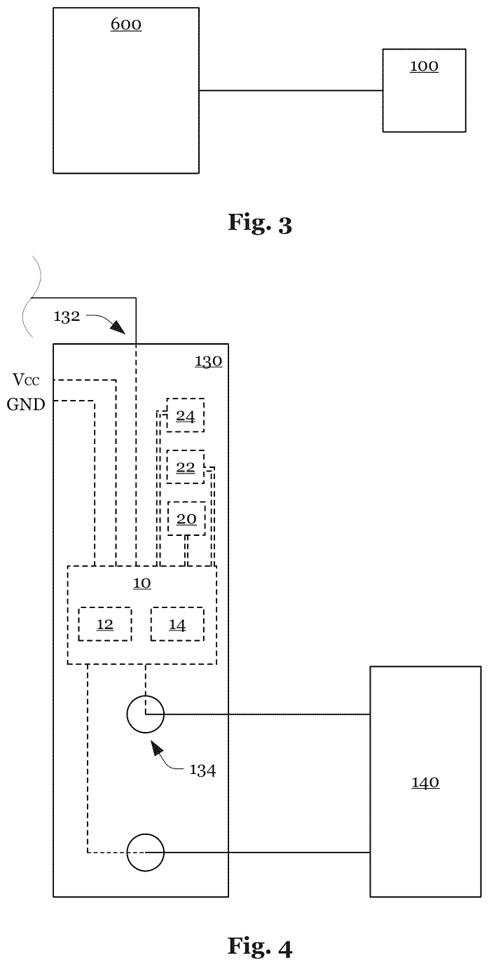

FIG. 3 shows a fieldbus node 100 and a computer 600 connected to the fieldbus node 100 (which may be, for example, a desktop, a laptop, a tablet, etc.), which is configured to effectuate the configuration of the I/O modules 120 and 130 of the fieldbus node 100. The computer 600 may serve solely or primarily for configuration purposes but may also perform other tasks (in addition to the configuration). For example, the computer 600 may be part of the higher-level controller 400 and, in addition to the configuration, also perform monitoring and/or control tasks. For example, the computer 600 may monitor the system and be configured to switch from one operating mode to another operating mode if certain conditions are met (and to change or update the configuration, if necessary, during the switching).

As part of the configuration, addresses (e.g., PROFIsafe addresses) may also be transmitted to the I/O modules 120 and 130, which are intended to be used by the I/O modules 120 and 130 to establish safety-related channels, so that data that is directed to the I/O modules 120 and 130 and that is relevant for the implementation of a safety-related function can be sent to the addresses. To establish a safety-related channel, it may be provided that the data and the address are embedded in messages addressed to the bus interfaces and the data are discarded by the respective I/O module 120 and 130 if the address does not match the address assigned to the respective I/O module 120 and 130. The address and/or data may be provided with a checksum and/or subjected to forward error coding to detect or correct errors.

If one or both of the I/O modules 120 and 130 are to establish a safety-related channel for communication, the (further) configuration may take place via the safety-related channel. If, for example, the I/O module 120 is not intended to perform any safety-critical functions, the I/O module 120 may be configured solely on the basis of the messages addressed to the bus interface 122. However, if the I/O module 130 is intended to perform safety-critical functions, which is assumed in the following, then after receipt and confirmation of the address intended for the safety-related communication, the (further) configuration (at least as far as it relates to the safety-related function) may be carried out via a safety-related communication channel established using the address.

As illustrated in FIG. 4, the I/O module 130 which is configured to perform a safety-related function may include a circuit 10 that reads the sensor signals from the sensor 140. The sensor signals may be read, for example, by the circuit 10 determining (with a specific sampling frequency) a voltage applied to input 134 or a current flowing through input 134. The circuit 10 may further comprise a processor 12 which is configured to execute a program (e.g., a command sequence) stored in a memory 14 of the I/O module 130, the program using configuration data to determine how to generate process data from the sensor signals and how to further process the process data (e.g., whether, when, or how often the process data is to be transmitted to the fieldbus coupler 110).

To increase reliability, the program may, for example, include redundantly programmed instruction threads whose results are matched. Furthermore, in contrast to the example shown in FIG. 4, two or more identical or different sensors 140 may be used, which, in the error-free case, deliver (approximately) identical sensor signals, so that the state of the sensors 140 can be determined by comparing the sensor signals. In addition, it is noted that, although FIG. 4 shows a sensor 140 as an exemplary field device, the field device connected to the I/O module 140 may also be an actuator, multiple actuators, or any other field device.

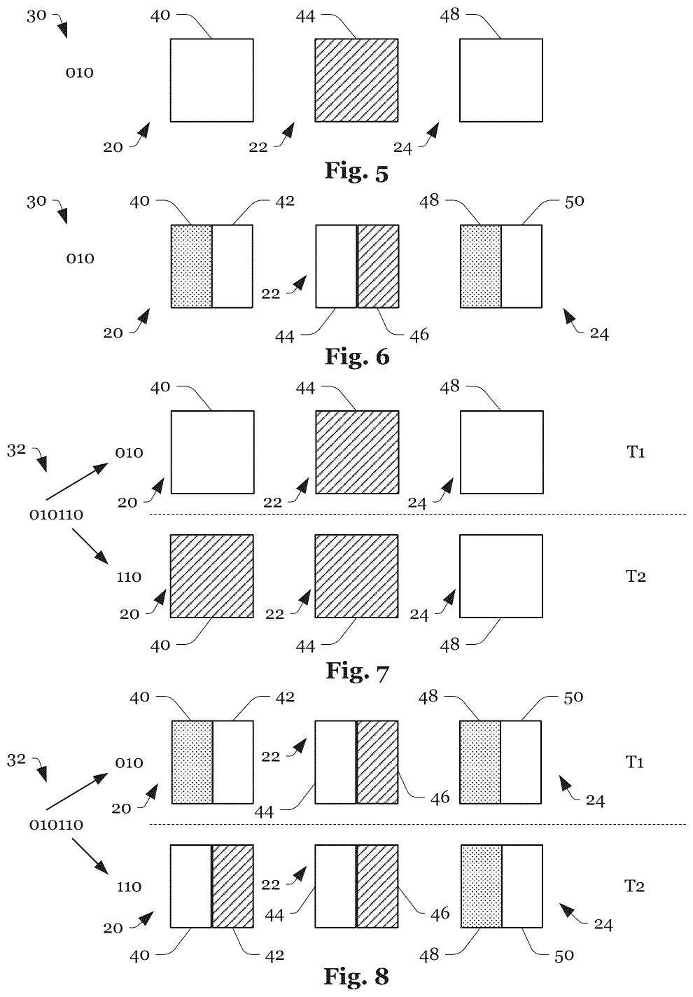

The I/O module 130 also includes several LEDs 20, 22 and 24, which indicate the operating state of the I/O module 130 during operation. In addition, LEDs 20, 22 and 24 are used to display an address assigned to the I/O module 130 for establishing a safety-related communication channel. FIG. 5 illustrates a possible presentation of a first address 30 in coded form. Each character (here: zeros and ones) of the character string representing address 30 is assigned a light-emitting component and, if the character is a “O”, the light-emitting component is not activated and if the character is a “1”, the light-emitting component is activated.

If the LEDs 20, 22 and 24 are multi-colored LEDs, as illustrated in FIG. 6, each character may be assigned to one of the LEDs 20, 22 and 24, wherein, if the character is a “0”, a first light-emitting component 40, 44 or 48 of the respective LED 20, 22 or 24 is activated, and, if the character is a “1”, a second light-emitting component 42, 46 or 50 of the LED 20, 22 or 24 is activated, wherein the light-emitting components 40, 44 and 48 and the light-emitting components 42, 46 and 50 differ in terms of the wavelength range or wavelength of the emitted light. For example, LEDs 20, 22 and 24 may be configured to light up green or red and light up green to display a “0” and red to display a “1”.

If the number of LEDs 20, 22 and 24 available for display is smaller than the number of characters in the character string, the character string may be segmented and different segments may be displayed one after the other, as illustrated in FIG. 7. For example, the first three characters of the string may be displayed by LEDs 20, 22 and 24 at time T1 and the last three characters of the string may be displayed by LEDs 20, 22 and 24 at time T2 by activating and deactivating the LEDs as described in connection with FIG. 5. Of course, as illustrated in FIG. 8, a segmented presentation may also be achieved using multi-colored LEDs by operating the LEDs (at times T1 and T2) as described in connection with FIG. 6.

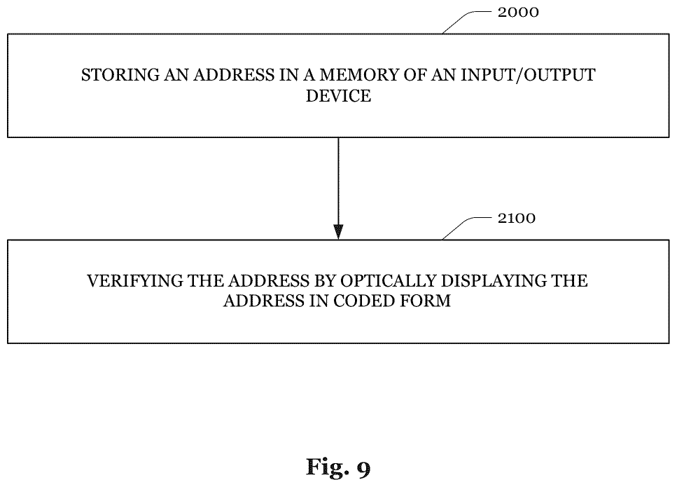

FIG. 9 shows a flow chart of a process. In step 2000, the address 30 or 32 is stored in the memory of an I/O device (e.g. in memory 14 of the I/O module 130). If it is determined in step 2100 when verifying the address 30 or 32 by means of optically displaying the address 30 or 32 that the stored address matches an address intended for the I/O device, the address may be used to establish a communication channel that is different and in particular more secure than other communication channels established by the I/O device.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An input/output device comprising:
an input and/or an output;
a bus interface;
a memory; and
at least two light-emitting components,
wherein the input and/or the output is configured to connect field devices,
wherein the bus interface is configured for indirect or direct connection of the field devices to a field bus,
wherein the memory is configured to store an address,
wherein the input/output device is configured to receive data directed to the address via the bus interface, and
wherein the input/output device is configured to display the address in coded form using the at least two light-emitting components.

2. The input/output device of claim 1, wherein the data is comprised in a message addressed to the bus interface and the input/output device is configured to extract the address from the message and store it in the memory.

3. The input/output device of claim 2, wherein the input/output device is configured, in response to a confirmation of the address, to use the address to establish a communication channel which is secured by other security mechanisms than the message addressed to the bus interface.

4. The input/output device of claim 1, wherein the input/output device is configured to display the address in digitally coded form using the light emitting components.

5. The input/output device of claim 4, wherein the address comprises a sequence of zeros and ones and the input/output device is configured to display a zero or a one in the sequence by deactivating or activating a light emitting component.

6. The input/output device of claim 5, wherein a first group of the light emitting components is configured to emit light of a first wavelength and a second group of the light emitting components is configured to emit light of a second wavelength, and wherein the first wavelength and the second wavelength correspond to different colors.

7. The input/output device of claim 5, wherein the input/output device is configured to display segments of the sequence one after the other and the zeros and/or ones in each segment simultaneously.

8. The input/output device of claim 7, wherein the input/output device is configured to display a segment which is displayed at a specific time by deactivating or activating individual ones of the light-emitting components.

9. The input/output device of claim 7, wherein the input/output device is configured to output a sequence-independent optical, acoustic, or haptic signal after the last segment and/or before the first segment, which signalizes the end of a presentation of the sequence and/or the beginning of the presentation of the sequence.

10. The input/output device of claim 1, wherein the input/output device is configured to restart the input/output device in response to a confirmation of the address and/or to use some or all of the light-emitting components to display further information.

11. A method for verifying an address of an input/output device, the method comprising:
storing the address in a memory of the input/output device; and
verifying the address by optically displaying the address in coded form.

12. The method of claim 11, wherein the address comprises a sequence of zeros and ones and the input/output device is configured to display a zero or a one in the sequence by deactivating or activating a light emitting component of the input/output device.
